(19) United States
(12) Patent Application Publication
(10) Pub. No.: US 2019/0183091 A1
(43) Pub. Date: Jun. 20, 2019

(54) IDENTIFICATION TAGS

(71) Applicant: Vium Inc, San Mateo, CA (US)

(72) Inventors: Jonathan Betts-LaCroix, Belmont, CA (US); Youssef Barhom, Arlingon, MA (US); Kyle Howard Heath, Menlo Park, CA (US); Pablo Jadzinsky, Palo Alto, CA (US)

(73) Assignee: Vium Inc., San Mateo, CA (US)

(21) Appl. No.: 15/849,430

(22) Filed: Dec. 20, 2017

(51) Int. Cl. A01K 11/00; G06K 7/14

(52) U.S. Cl. CPC A01K 11/004; G06K 7/1417; A01K 11/006

(57) ABSTRACT

Aggregates of sets of identification tags are described, such as may be used on animals, such as mice or rats, affixed to ears or attached otherwise to an animal. A set may comprise from two to five patterns. An aggregate may comprise one to five sets. Patterns comprise a perimeter with an interior contrasting field, optional contrasting shapes within the field, and an optional contrasting shape core within a shape. Simple shapes may be squares, circles, or triangles. Shapes are selected for maximum machine readability. A pattern may have from zero to three shapes in its field. Patterns within sets are selected for maximum differentiation between the patterns in the set. Aggregates are selected based on the number of different sets required. Identification tags may be used to uniquely identify animals in a cage. Shown are specific patterns for embodiments of devices, systems and methods.

### FIELD OF THE INVENTION

The field of this invention is identification tags. More specifically, identification tags that may be placed on an animal, such as on an animal ear or ears, to uniquely identify the animal in an environment, such as a cage, study or vivarium.

### BACKGROUND OF THE INVENTION

Animals, including research animals, such as mice or rats, are typically housed in cages in a vivarium. If multiple animals are placed in a single cage, the animals and the cages are said to be, “multihoused.”

Such animals, in a study, are examined or monitored, either manually or electronically, to detect and quantify various behaviors, characteristics, or, “phenotypes,” identified individually or in aggregate, herein as, “behaviors.” It is critically important that such behaviors be associated with a specific animal in a cage. Various methods of such identification are used in the art, such as RFID tags, which may be implanted or attached to the animal; tattoos, such as tail tattoos; and ear notches.

In an automated environment, it is important that any such animal's unique identification (ID) be read electronically, reliably, inexpensively, where the animal may be at various locations within a cage and at various orientations to a sensor. In addition, visible or infrared (IR) light may be used in the cage. Further, any physical identification device must be resistant to chewing and not injure either the so identified animal or other animals in a cage. If a vision system is used to identify animals, then a visible tag, such as an ear tag, should be at least partially orientation insensitive and able to be read using low resolution video imaging.

### SUMMARY OF THE INVENTION

Embodiments overcome limitations in the prior art. Embodiments include aggregates of sets, sets, and patterns.

Embodiments include aggregates of one to five sets. A set may comprise from two to six patterns. Patterns comprise a perimeter with an interior contrasting field, optional contrasting shapes within the field, and an optional contrasting shape core within a shape. Simple shapes may be squares, circles, or triangles. Shapes are selected for maximum machine readability. A pattern may have from zero to three shapes in the field. Patterns within sets are selected for maximum differentiation between the patterns in the set. Aggregates are selected based on the number of different sets required. Identification tags may be used to uniquely identify animals in a cage. For example, a cage with two animals needs a set with two patterns. A cage with five animals needs a set with five patterns. A vivarium with cages that contain one to four animals in a cage needs an aggregate with three sets (with two, three and four patterns in each set) because cages with a single animal do not need a separate method of uniquely identifying multiple animals in a cage.

Embodiments include ear tags, comprising a readable face and a rear post that may penetrate an ear and be retained by a suitable clip, similar to well-known human earrings. Embodiments include pattern sets with two patterns for two animals in a cage; three patterns for three animals in a cage, four patterns for four animals in a cage; and five patterns for five animals in a cage. Embodiments include pattern sets where any pattern in the set may be rotated to any of four 90° rotations while retaining pattern uniqueness within the set. Some patterns are rotationally insensitive to these four rotations. Some patterns are rotationally insensitive to only 180° rotations. Some patterns are not rotationally insensitive. Embodiments include patterns where the shape of each pattern is contained within a rounded-corner square. At the perimeter of the square is a thick line in the form of a ring, the “perimeter,” of a first color. Inside the perimeter is a “field” color of a second, contrasting color. Inside the perimeter are one or more “interior shapes” of the first color. The interior shapes are completely surrounded by the field color.

A goal of embodiments is to have the simplest possible set of patterns that are vision-based, electronically identifiable as unique within a cage for two, three, four or five animals in the cage. Thus, we describe, for each embodiment, a “set of patterns,” where the set consists of two, three, four or five patterns, respectively.

Embodiments overcome limitations in the prior art. A key benefit is more reliable reading under both visible and IR light, independent of animal location or orientation in the cage, using low-resolution video imaging.

Method embodiments include both placing and using such ear tag device embodiments; using such device embodiments within a vivarium; and video recognition methods. Another method includes using such ear tag pattern sets as part of health determination or treatment efficacy.

### BRIEF DESCRIPTION OF THE DRAWINGS

FIG. 1 shows details of elements in an embodiment of both ID tags and ID tag patterns.

FIG. 2 shows details of a single tag pattern.

FIG. 3 shows patterns for a set of three tags and a set with six or fewer patterns.

FIG. 4 shows a set for three patterns with inverted colors.

FIG. 5 shows elements for a method of constructing a set of four patterns or four tags.

FIG. 6 shows elements for a method of constructing a set of six or fewer patterns or tags.

FIG. 7 shows an embodiment with two animals with tags used as ear tags in a multihoused cage.

### DETAILED DESCRIPTION OF THE INVENTION

Embodiments described are non-limiting.

Animal ID tags, or “ear tags,” in one embodiment, may be placed through one or two ears of animals singly house or multihoused. For multihoused animals, reading the tags with a video camera, ideally placed outside the cage with no electrical penetrations through the cage, using both visible and IR light, is a typical embodiment. The term, “IR light,” may be construed, in some embodiments, as any spectra of light that is not generally visible to animals used in a study. This light may be used to observe animals during their natural nocturnal period, without disturbing them.

FIG. 2 shows an embodiment of a single pattern for a single tag. Here, as in other Figures, the hatching 40 indicates areas around the tag not part of the tag; that is, with respect to the tag, this hatched area is “nothing.” This hatching is used in Figures to clearly identify the elements and physical boundary of one or more tags or tag patterns. 41 is a perimeter in a first color; here, a dark color, such as black. Note that elements 41, 42, and 43 are all on the surface of a tag. Another embodiment consists of just sets of patterns; not included in the embodiment are physical tags supporting the patterns. Tags may be printed, embossed, injection molded, double-shot injection molded, hot-stamped, plated, or manufactured by other means. The term, “perimeter,” used herein with respect to a pattern, is part of the pattern, not an outside surface perpendicular to the face of the tag. Note that the width of perimeter line is, “wide,” in the sense that it is clearly visible in a low-resolution digital image. The shapes shown in Figures are rounded-corner squares, such as shown here. Other shapes of tags may be used, including square, rectangular, circular, oval, racetrack and the like. However, rounded corners are desirable to avoid injuring animals and to avoid providing an attractive corner for chewing. The term “rotational symmetric,” means that the pattern is the same for any one of four 90° rotations, unless otherwise stated. 42 is the “field,” in a second, contrasting color. Note that the field 42 is in contact with the entire inside edge of the perimeter 41. Black and white make good contrasting colors, however many others may be used. For some embodiments, it is important that the colors remain high contrast in both visible and IR light. The most common colors for the fur of mice and rats are black and white. It is desirable that the perimeter in the first color be high contrast against the animal's fur color. Thus, one set of tags may have white perimeters to use, ideally, on black animals; while a second set of tags may have black perimeters to use on white animals. However, a novelty of embodiments, with both a first color perimeter and a contrasting color field is that they are highly machine-recognizable on any color animal. In addition, a novelty and claimed embodiment is that inverse colors may be used on any number of tags in a set without impacting either uniqueness or readability. 43 is the “shape,” in the first color, to stand out against the field. Here it is a black square with or without rounded corners. Note that the field completely surrounds any number of shapes on the tag. The combination of a perimeter, a field, one or more optional shapes in the field, and any optional, “shape cores,” constitutes a, “pattern.” Claimed embodiments include sets of tags and sets of tag patterns where any number of elements in the set may substitute with an element of the same pattern but with the first and second colors swapped. That is, colors may be inverted; e.g., substitute black for white and white for black.

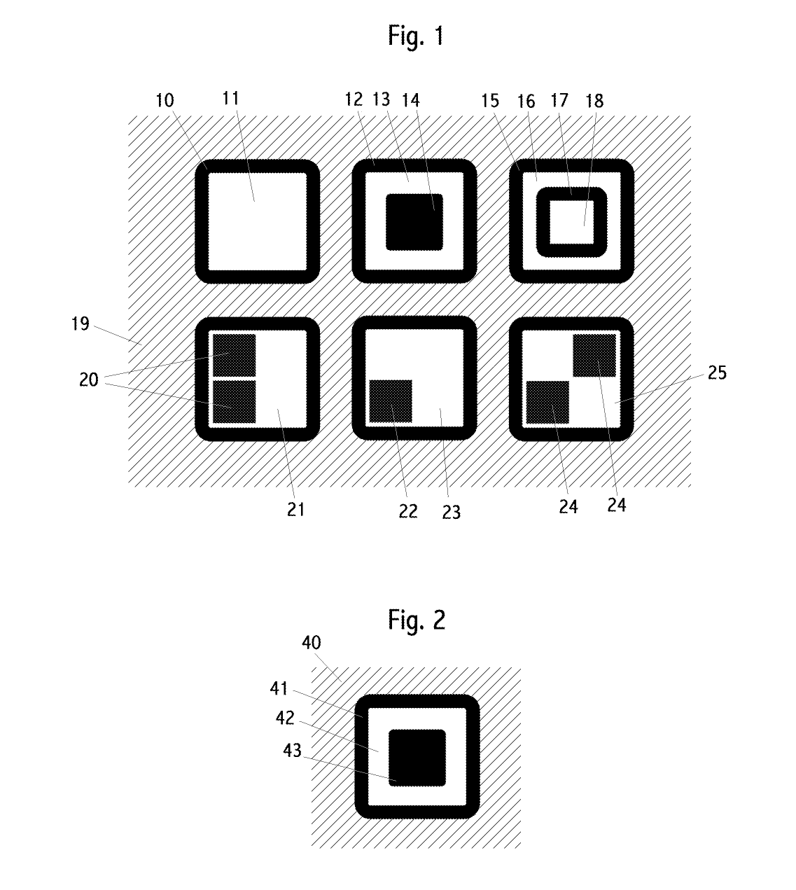

Turning now to FIG. 1, we see six different patterns. As with FIG. 2, the hatched area 19 indicates, “nothing.” It may be though of as air or animal skin or animal fir under or around a physical tag. Or the hatched area may designate the limit of patterns in the FIG. 10 is the perimeter of the first pattern in the Figure. Here the field 11 has no internal shapes. The pattern for this first tag is the combination as shown of 10 and 11. The second tag pattern consists of perimeter 12, field 13 and shape 14. The third tag pattern consists of perimeter 15, field 16, shape 17, with a “shape core” of 18. Note that if a shape has a core the core is completely surrounded by the shape, and the shape core is the field color.

Continuing with FIG. 1, a fourth tag pattern consists of a perimeter with field 21 and two shapes, 20. The field 21 surrounds both shapes 20. Note that this pattern is not rotationally symmetric, unlike the first three tag patterns. A fifth tag pattern consists of the perimeter with field 23 and shape 22. A sixth tag pattern consists of a perimeter, field 25 and two shapes 24. A novel feature of the fourth, fifth, and sixth tag patterns as a set of three is than any combination of these three patterns are recognizably distinct in any orientation. All six shapes in FIG. 1 are recognizably distinct in any orientation. Thus, the patterns shown in FIG. 1 may be used to construct a set comprising one to six patterns or one to six tags.

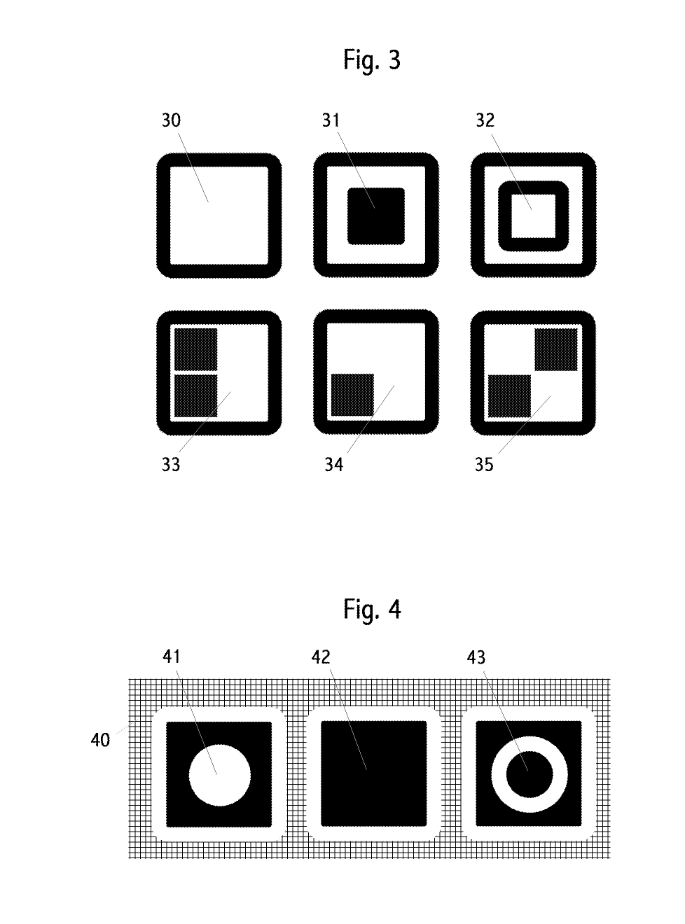

Turning now to FIG. 3 we see the same six patterns as in FIG. 1. Hatching is not needed in the Figure because the perimeter for all patterns is black and the page color is white. It is now convenient to use reference designators to more easily identify patterns within a set. Here, 30, 31, 32, 33, 34 and 35 are six distinct tag patterns. A pattern set consisting of two patterns may be any combination of two patterns out of the patterns 30, 31 and 32, preferable 30 and 31. A pattern set consisting of three patterns may be 30, 31 and 32. A pattern set consisting of four patterns may be 30, 31, 32 and any one of 33, 34, or 35. A pattern set consisting of five patterns may be 30, 31, 32, and any two of 33, 34, and 35. A pattern set consisting of six patterns may be all patterns 30-35.

Turning now to FIG. 4, we see an alternate embodiment of pattern sets for two and three patterns. In this Figure, hatching 40 is again used to show the physical extent of tags and tag patterns. Perimeters of patterns in this Figure are white, as the first color. Note that embodiments use the same physical tag size for all tags in a set, and use the same perimeter for all patterns in a set, and use the same first and second colors. Here, pattern 41 has a white solid circle as a shape on a black field. Pattern 42 has a solid black field with no interior pattern shape. Pattern 43 has a black field with a white ring pattern shape with a circular white shape core.

An embodiment of a set of two tags or patterns on tags consists of any two of patterns 41, 42 and 43, preferably 41 and 42. An embodiment of a set of three tags or patterns on tags consists of 41, 42 and 43; or their inverse colors.

It is important to note that the patterns and shapes herein described are not arbitrary design choices because they provide exceptionally high readability in adverse environments, such as tilted at an angle to a camera, poor lighting, contamination with bedding or other detritus, variable distance to a camera, motion blur, rotation, and the like. In addition, these patterns are particularly well suited to efficient vision recognition algorithms, as discussed in more detail below.

Tags may be place on either one or two ears. They may be placed on or affixed to other locations of an animal. They may be tattooed, painted, or dyed on an animal's skin or fur.

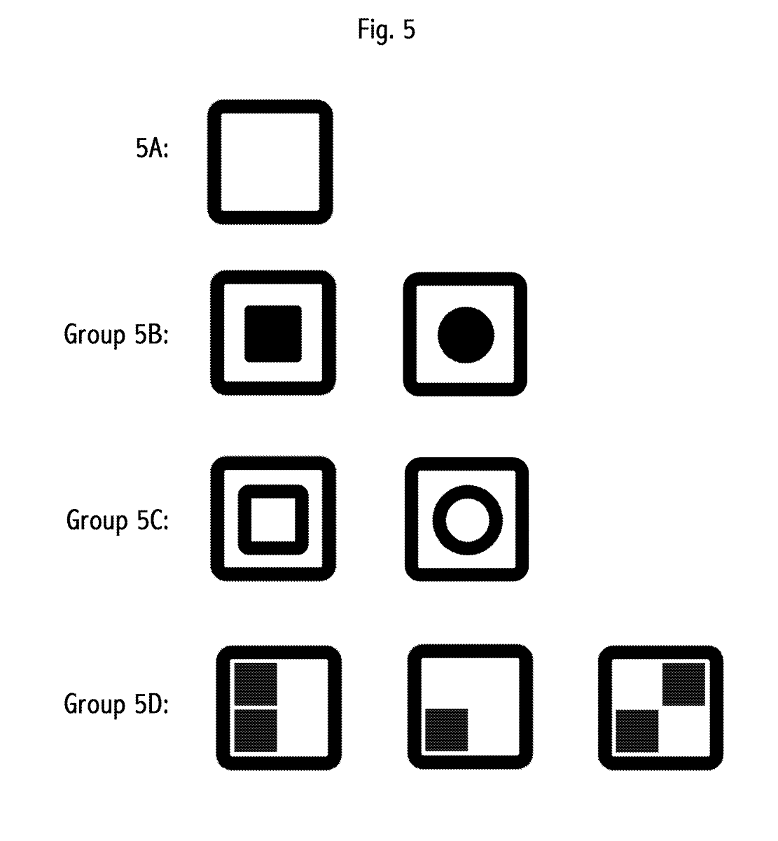

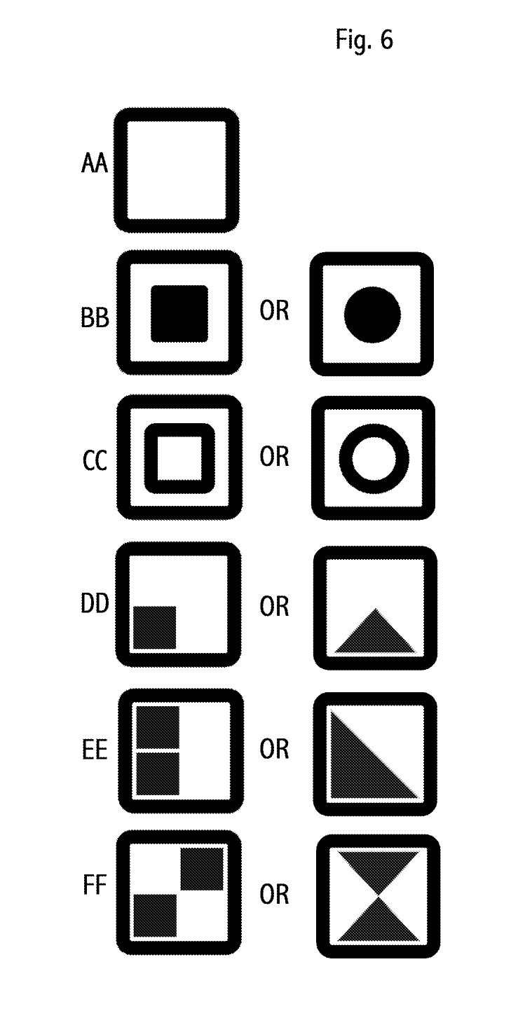

Turning now to FIG. 5 we see pattern elements for methods of creating a set of tags or tag patterns. Here shown are elements for a method of creating a set of four or fewer ID tags or patterns. The method comprises: using the one pattern 5A; and one pattern from group 5B, and one pattern from group 5C, and one pattern from Group 5D. A set with three or two patterns may be constructed using this method and then selecting a total of only three or two patterns from those five first selected. An alternative embodiment comprises: using the one pattern 5A; and one pattern from group 5G, and one, two, or three patterns from group 5C. This method may be used to construct sets of four, five, or six tags or patterns. Fewer than six tags or patterns may be created by then choosing fewer tags from those tags or patterns just selected.

Turning now to FIG. 6 we see embodiments of pattern elements for methods of creating a set of tags or patterns consisting of six or fewer tags or patterns. To create a set of six, select tag pattern AA, plus one each from BB, CC, DD, EE, or FF respectively, as shown. For a set of two to five tags or patterns, now select the desired number from the six just selected.

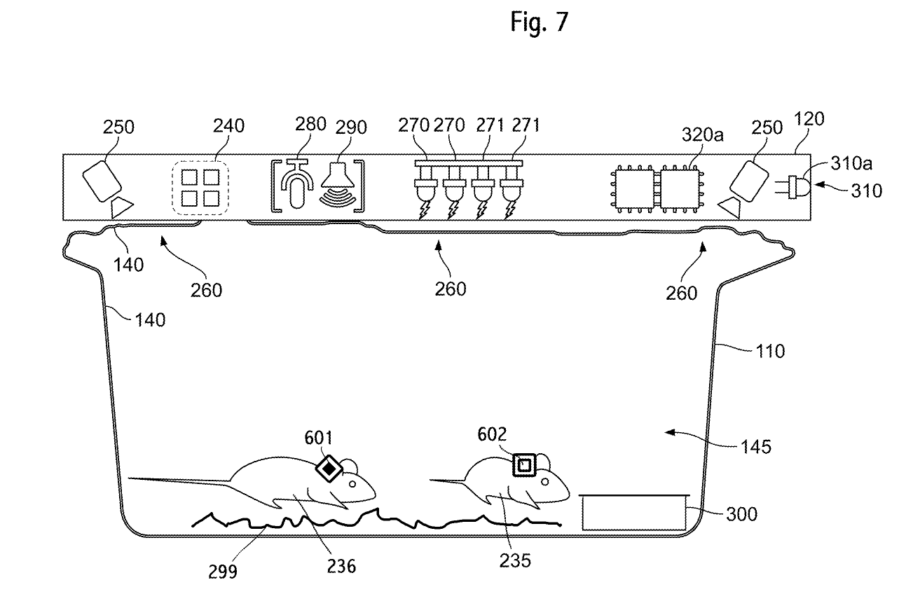

Turning now to FIG. 7, we see a schematic side view of a cage with two animals each wearing one pattern, from a set of two, as ear tags, plus sensors in the cage to read the tags. The tags may be on either one or two ears of each animal, the tags or patterns may be attached elsewhere to the animal. The periphery of the cage, often constructed from clear plastic, is shown as 110 and 140, for the outside and inside surfaces respectively. The interior of the cage, ideally sterile, per the definition of sterile in this specification, is 145. Thus the sterile border is between 140 and 110. Bedding or bedding area is shown 299. A scale, typically a wireless, sterilizable, re-useable scale is shown 300. The scale may be below a water bottle, not shown, to encourage mice to climb on the scale regularly. Exercise equipment is not shown. 260 shows in three places clear areas at the top of the cage through which cameras 250 may view the inside of the cage, and through which visible light and infrared light, from LEDs 270 and 271, respectively, may enter the cage. Light from such LEDs 270 and 271 may be required or used conveniently to read ID tags. IR light is appropriate as many animals, including mice, which are nocturnal. Providing visible light to the animals during their natural activity period either causes them to change their circadian activity or it disturbs their natural activities and may cause stress, or all of these. Cages may be disposable or sterilized between studies. Ideally, and key to some embodiments, is that there are no electrical penetrations of the cage periphery, 110 and 140. Cameras, which may be still or video, monochrome, color or infrared (IR), multiple or single, are shown 250. Ideally only a single camera is used. 280 and 290 show respectively a microphone and speaker, which may be used for either ambient (vivarium) or in-the-cage audio use. 240 shows exhaust air sensors, such as temperature, humidity, ammonia concentration, and the like. 320a shows local processing electronics, which may include CPU, analog and digital processing, including video image processing, non-transitory data storage and communication, in any combination. 310a shows an LED pointing away from the cage, which may be used as an indicator for humans, such as to indicate that the cage needs attention, or as an optical communications element. Other communication elements, not shown, may be wireless or wired. 310 shows a base, enclosure or “slab” that contains some or all of the electronics and sensors. Ideally this slab 310 is separate from the cage 110, so that cages may be easily moved, removed, swapped, or replaced without disturbing the electronics, and similarly, all of the electronics in the slab 310 may easily be installed, serviced, updated, or swapped, without tools, as slab units, without disturbing the cage or its animals. Cages may slide in and out of their holding racks on rails, while the slap is mounted overhead each cage. Similarly, slabs may sit simply on supports, with electrical connection via a connector or fingers. In this way, both the electronics and the cages may be removed and replaced without disturbing the other. Other sensors may also or alternatively be used, as discussed below. Husbandry elements such as food, water and exercise equipment are not shown. Also not shown in this Figure are supply and exhaust air ducting. These husbandry elements may also be monitored by the sensors in slab 310 or by sensors elsewhere.

Two animals are shown in FIG. 7 as 235 and 236. Here, there are two mice. As described above and below, embodiments may use a wide range of animals for studies. The identities of the two mice, 235 and 236, are distinguished in different embodiments by identification devices, such as ear tags, here shown as 601 and 602. Tags may be read using, in part, one or two cameras 250. Identification of animals is discussed below.

Microphone 280 may receive either human-range audible vocalizations or ultrasonic vocalizations, or both. This microphone may also pickup spoken information from technicians in the vivarium. Speaker 290 may be used to provide audible information to a vivarium technician, background sounds that are husbandry compatible, including white noise, or non-husbandry stimulation.

The cage hardware as shown is capable of providing some non-husbandry stimulation, such as sound and light. Stimulations of this type are not part of embodiments herein, unless otherwise clear from the context.

Either LEDs 270 and 271 may provide circadian light for the animals in the cage, or such lighting may be provided generally within the vivarium, not shown.

FIG. 7 is schematic only. Actual sensors and cage design may differ substantially from the shapes and locations shown. Embodiments may use more elements or fewer elements than shown. Husbandry elements such as a water bottle, food tray, exercise equipment, nesting locations, chewable objects, and the like are not shown. Note that this cage is free of electronic penetrations.

Note that the tags 601 and 602 are part of a set of two tags or patterns. Their purpose, generally, is to uniquely identify animals in a single multihoused cage. For unique identity of animals within one study, or one vivarium, additional identification is typically needed, such as a cage ID. Note that in this Figure tag 601 is shown rotated about 45 degrees. If tags are secured to ears with a single pin, such rotation is common. That is one reason why patterns within a set should be rotationally unique.

Ideally, when selecting patterns for a set of patterns or a set of tags, patterns will be selected that are maximally “spaced,” within an algorithm for reading, to minimize a chance that one pattern is mistaken for another, or that a pattern read is indeterminate.

### ID Tag Image Recognition

The following image-based methods may be used to locate and identify ID tags within a set of ID tags. Typically, a “classifier” is top-level method, which then uses “features” within the classifier. Classifiers include: SVM, cascade classifier, boosted forest, random forest, and ANN (Artificial Neural Networks for a large class). Features include ORB, SIFT, SURF, HOG, Haar-like features, and Viola-Jones. Either features or raw pixels may be analyzed using CNN (Convolution Neural Networks), R-CNN, or YOLO classifier, typically within a small area of a large image, such as a video frame. Additional information about these methods may be found in the list below:
https://en.wikipedia.org/wiki/Haar-like_feature
https://en.wikipedia.org/wiki/Cascading_classifiers
https://docs.opencv.org/3.3.0/d7/d8b/tutorial_py_face_detection.html
https://www.tnt.uni-hannover.de/papers/data/977/scia2013_baumann.pdf
https://www.learnopencv.com/image-recognition-and-object-detection-part1/
https://en.wikipedia.org/wiki/Artificial_neural_network

The above references were retrieved on 11 Dec. 2017.

### Notes on Claims

With respect to claims, it is preferred that claims refer directly to patterns shown in the Figures. However, in the event that such direct reference to

Figures is not available, text, such as provided herein, may be used, as appropriate, to substitute for such direct references.
With respect to FIG. 6 and claims thereto, but not exclusively to such:
A pattern comprises a perimeter in the form of a ring of a first color; a field, within the perimeter, in contact with an entire inside edge of the perimeter, of a contrasting, second color; an optional shape of the first color, within the field, wherein the optional shape is completely surrounded by the field; and an optional shape core of the second color inside the optional shape, wherein the optional shape core is completely surrounded by the shape.
A shape repertoire comprises six patterns, wherein the six patterns comprise:
(a) a first pattern consisting of a perimeter and a first field with no shape and with no shape core;
(b) a second pattern consisting of the perimeter and the first field and a single first shape and no shape core; wherein the first shape is centered within the field;
(c) a third pattern consisting of the perimeter and the first field with single second shape and a single shape core; wherein the second shape is centered within the field;
(d) a fourth pattern consisting of the perimeter and the first field with a single third shape and with no shape core; and wherein the third shape is off-center within the field;
(e) a fifth pattern consisting of either: (i) the perimeter and the first field with exactly two copies of a fourth shape, wherein the fourth shape is smaller than the first shape, or (ii) the perimeter and the first field with a fifth shape, wherein the fifth shape is different than either the first or second shape;
(f) a sixth pattern consisting of the perimeter and the first field with exactly two copies of a sixth shape, and with no shape core;
wherein the second shape may be the same as the first shape;
wherein the sixth shape may be the same as the third shape;
wherein the first, second and third patters are rotationally symmetric for 90 degree rotations;
wherein the fourth, fifth and sixth patterns are not rotationally symmetric for 90 degree rotations;
wherein the sixth shape is rotationally symmetric for 180 degree rotations;
wherein any two shapes may be different due solely to the size of the shape.
The shapes shown in FIG. 5 are an appropriate subset of the shapes shown in FIG. 6

Animal ID may be via including tracking an animal in the cage, using a vision system, such as comprising a camera 250 from a point in the cage where animal ID is confidently determined, such as for animal 236, to a point where animal ID is not otherwise directly determinable.

A method of identifying uniquely animals in a cage may be, first confidently identifying, via reading one or more ID tags, all animals in a cage except one; and then thus knowing the identity of that one animal. For example, knowing the identify of animal 236 from reading tag 601 may be used to identify animal 235 even if 602 is not readable.

Embodiments for this invention include sets of ID tags and sets of ID patterns. Embodiments include method of creating tag sets; method of applying tag sets to animals in a cage; methods of uniquely identifying animals in a cage using a such a set of tags; systems for these methods; and devices adapted to perform such method steps.

Embodiments specifically claimed include identification tags, sets of identification tags, methods of creating a set of identification tags, aggregates of sets of sets identification tags, methods of use of sets of identification tags; methods of use of sets of identification tags using an automated vision system for animals so tagged in multihoused cages in a vivarium.

Specifically claimed are all claims and embodiments as written or shown, with an additional limitation that, any number of original patterns in the set may be substituted with a substitute pattern equal to the original pattern with the first and second colors swapped.

All examples are sample embodiments. In particular, the phrase “invention” should be interpreted under all conditions to mean, “an embodiment of this invention.” Examples, scenarios, and drawings are non-limiting. The only limitations of this invention are in the claims.

May, Could, Option, Mode, Alternative and Feature—Use of the words, “may,” “could,” “option,” “optional,” “mode,” “alternative,” “typical,” “ideal,” and “feature,” when used in the context of describing this invention, refer specifically to various embodiments of this invention. Described benefits refer only to those embodiments that provide that benefit. All descriptions herein are non-limiting, as one trained in the art appreciates.

All numerical ranges in the specification are non-limiting examples only.

Embodiments of this invention explicitly include all combinations and sub-combinations of all features, elements and limitation of all claims. Embodiments of this invention explicitly include all combinations and sub-combinations of all features, elements, examples, embodiments, tables, values, ranges, and drawings in the specification and drawings. Embodiments of this invention explicitly include devices and systems to implement any combination of all methods described in the claims, specification and drawings. Embodiments of the methods of invention explicitly include all combinations of dependent method claim steps, in any functional order. Embodiments of the methods of invention explicitly include, when referencing any device claim, a substitution thereof to any and all other device claims, including all combinations of elements in device claims.

We claim:

1. A set of identification tags comprising:
any two to six patterns shown in FIG. 3, wherein a pattern is used only once in the set.

2. A set of three identification tags comprising:
patterns 30, 31 and 32 shown in FIG. 3.

3. A method of identifying animals in a cage comprising the steps:
selecting a quantity of animals in the cage wherein the quantity is in the range of two to six inclusive;
selecting a set of patterns from the patterns shown in FIG. 3, wherein a size of the set is equal to the quantity of animals in the cage and wherein a pattern is used only once in the set;
placing a set of tags, each unique tag in the set comprising one pattern from the set of patterns, on the animals in the cage, one tag per animal; and
recognizing a unique identification of an animal in the cage using machine vision responsive to the unique tag on each animal.

4. A set of three to six identification tag patterns comprising:
pattern 5A shown in FIG. 5;
exactly one pattern from group 5B shown in FIG. 5;
exactly one pattern from group 5C shown in FIG. 5; and
exactly zero to three patterns from group 5D shown in FIG. 5.

5. A method of creating a set of three to six identification tags comprising the steps:
placing a tag with pattern AA, shown in FIG. 6, into a pattern set;
placing exactly one tag with a pattern from set BB, shown in FIG. 6, into the pattern set;
placing exactly one tag with a pattern from set CC, shown in FIG. 6, into the pattern set;
placing exactly one tag with a pattern from set DD, shown in FIG. 6, into the pattern set;
placing exactly one tag with a pattern from set EE, shown in FIG. 6, into the pattern set;
placing exactly one tag with a pattern from set FF, shown in FIG. 6, into the pattern set; and
selecting three to six patterns from the pattern set;
wherein the set of three to six identification tags consists of tags, each tag comprising exactly one pattern from the pattern set.
